(19) United States
(12) Patent Application Publication
(10) Pub. No.: US 2013/0185648 A1
(43) Pub. Date: Jul. 18, 2013

(54) APPARATUS AND METHOD FOR PROVIDING USER INTERFACE

(71) Applicant: Hyun-Jun KIM, Osan-si (KR)

(72) Inventor: Hyun-Jun KIM, Osan-si (KR)

(73) Assignee: Samsung Electronics Co., Ltd., Suwon-si (KR)

(21) Appl. No.: 13/743,453

(22) Filed: Jan. 17, 2013

(30) Foreign Application Priority Data
Jan. 17, 2012 (KR) 10-2012-0005400

(51) Int. Cl. G06F 3/048

(52) U.S. Cl. CPC G06F 3/048
USPC 715/744

(57) ABSTRACT

An apparatus and a method of providing a user interface are provided. An apparatus for providing user interface includes: an information gathering unit configured to collect application information related to applications that are executed and emotion information related to a user; a characteristic information generator configured to combine the application information and the emotion information to obtain characteristic information; and a user interface reconfiguration unit configured to reconfigure graphic objects related to the applications using the characteristic information.

### CROSS-REFERENCE TO RELATED APPLICATION

This application claims the benefit under 35 U.S.C. §119(a) of a Korean Patent Application No. 10-2012-0005400 filed on Jan. 17, 2012, in the Korean Intellectual Property Office, the entire disclosure of which is incorporated herein by reference for all purposes.

### BACKGROUND

1. Field

The following description relates to a graphic user interface and, for example, to an emotion recognition technique.

2. Description of the Related Art

A Graphic User Interface (GUI) is a computer interface that allows a user to interact with a computer by correlating specific functions and applications with graphic components, such as graphic objects, frames, colors, and the like, that are displayed on a screen.

In order to activate a certain function through a GUI, a user manipulates a graphic component that corresponds to the desired function. For example, a GUI may operate by allowing a user to select, move, or copy one of several graphic components displayed on a screen. The graphic components may be created with visual elements that metaphorically or representatively express specific functions in a 2-dimensional or 3-dimensional virtual space.

Recently, an electronic device such as a smart phone is often equipped with a touch panel, a camera or other input devices, making it possible for a user to interact with such an electronic device in various ways, including, for example, to collect information about the user or the location of the device.

### SUMMARY

In one general aspect, there is provided an apparatus for providing user interface including: an information gathering unit configured to collect application information related to applications that are executed and emotion information related to a user; a characteristic information generator configured to combine the application information and the emotion information to obtain characteristic information; and a user interface reconfiguration unit configured to reconfigure graphic objects related to the applications using the characteristic information.

The apparatus may further comprise a display unit configured to display the reconfigured graphic objects.

The apparatus may further include a setting unit configured to set a graphic object reconfiguration method of the user interface reconfiguration unit according to information collected by the information gathering unit or according to a user's input.

The graphic objects may be execution icons of the applications.

The user interface reconfiguration unit may be configured to classify the graphic objects according to the emotion information of the characteristic information.

The user interface reconfiguration unit may be configured to change a border, a color, or a size of at least one of the graphic objects according to the emotion information.

The user interface reconfiguration unit may be configured to group the graphic objects into several groups according to the emotion information.

The user interface reconfiguration unit may be configured to add or update identification icons associated with the graphic objects according to the emotion information.

In another general aspect, there is provided an apparatus for providing user interface including: an information gathering unit configured to collect application information related to applications that are executed and context information related to a use of the apparatus; a characteristic information generator configured to combine the application information and the context information to obtain characteristic information; and a user interface reconfiguration unit configured to reconfigure graphic objects related to the applications using the characteristic information.

The apparatus may further include a setting unit configured to set a graphic object reconfiguration method of the user interface reconfiguration unit according to information collected by the information gathering unit or according to a user's input.

The graphic objects may be execution icons of the applications.

The user interface reconfiguration unit may be configured to classify the graphic objects according to the context information of the characteristic information.

The user interface reconfiguration unit may be configured to change a border, a color, and a size of the graphic objects, according to a circumstance of the use included in the context information of the characteristic information.

The user interface reconfiguration unit may be configured to group the graphic objects into a plurality of groups, according to a circumstance of the use included in the context information of the characteristic information.

The user interface reconfiguration unit may be configured to add or update identification icons associated with the graphic objects, according to a circumstance of the use included in the context information of the characteristic information.

In another general aspect, there is provided an apparatus for providing user interface including: an information gathering unit configured to collect application information related to applications that are executed, emotion information related to a user, and context information related to a use of the apparatus; a characteristic information generator configured to combine the application information, the emotion information, and the context information to each other to obtain characteristic information; and a user interface reconfiguration unit configured to dynamically reconfigure graphic objects related to the applications using the characteristic information.

The apparatus may further include a setting unit configured to set a graphic object reconfiguration method of the user interface reconfiguration unit according to information collected by the information gathering unit or according to a user's input.

The graphic objects may be execution icons of the applications.

The user interface reconfiguration unit may be configured to classify the graphic objects in considerations of at least one type of emotion included in the emotion information or at least one type of circumstance included in the context information.

The user interface reconfiguration unit may be configured to change a border, a color, or a size of one of the graphic objects according to the emotion information or according to the context information.

The user interface reconfiguration unit may be configured to group the graphic objects into a plurality of groups according to the emotion information or according to the context information.

The user interface reconfiguration unit may be configured to add or update identification icons associated with the graphic objects according to the emotion information or according to the context information.

In another general aspect, there is provided a method for providing user interface including: collecting application information related to applications that are executed, emotion information related to a user, and context information related to a use of an apparatus; combining at least two pieces of the application information, the emotion information, and the context information to each other to obtain characteristic information; and reconfiguring graphic objects that are displayed on a screen using the characteristic information.

The method may further involve: retrieving the characteristic information from a memory storage; and dynamically reconfiguring the graphic objects displayed on the screen, wherein the graphic objects include an execution icon of at least one of the applications.

The graphic objects may include an execution icon displayed on the screen of a mobile terminal.

The reconfiguring of the graphic objects may involve: changing a color of the graphic objects displayed on the screen; changing a border of the graphic objects displayed on the screen; changing a size of the graphic objects displayed on the screen; changing a shape of the graphic objects displayed on the screen; or adding or changing an emoticon or identification icon associated with the graphic objects on the screen.

The memory storage may be configured to store the characteristic information related to a past history of a user's emotion associated with using at least one of the applications.

The memory storage may be configured to store the characteristic information related to a past history of a use of at least one of the applications.

A non-transitory computer readable medium configured to cause a computer to perform the above-described method is also provided.

Other features and aspects will be apparent from the following detailed description, the drawings, and the claims.

### BRIEF DESCRIPTION OF THE DRAWINGS

FIG. 1 is a diagram illustrating an example of an apparatus providing user interface.

FIG. 2 illustrates an example of characteristic information.

FIG. 3 illustrates another example of characteristic information.

FIG. 4 illustrates another example of characteristic information.

FIG. 5 is a diagram illustrating an example of a graphic object reconfiguration method.

FIG. 6 is a diagram illustrating another example of a graphic object reconfiguration method.

FIG. 7 is a diagram illustrating another example of a graphic object reconfiguration method.

FIG. 8 is a flowchart illustrating an example of a method for providing user interface.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Provided herein are descriptions relating to examples of apparatuses and methods for providing a user interface. For example, the apparatuses and methods may provide a user interface that is capable of reconfiguring graphic objects according to the emotional state of a user or according to the circumstance under which the terminal is used, such as the location, frequency and time.

For example, with the increased capability of portable electronic devices, there are interests in developing a technology that recognizes a user's emotions through various sensors provided in an electronic device. Studies are being conducted into technologies for recognizing a user's emotion through various sensors of electronic devices.

For instance, many smart phones are equipped with a touch panel, a camera and an audio recorder. With the increased capability, an electronic device, for example, may be configured to provide appropriate services in consideration of a recognized emotional state of a user, thereby increasing the user's ability to interact with the electronic device.

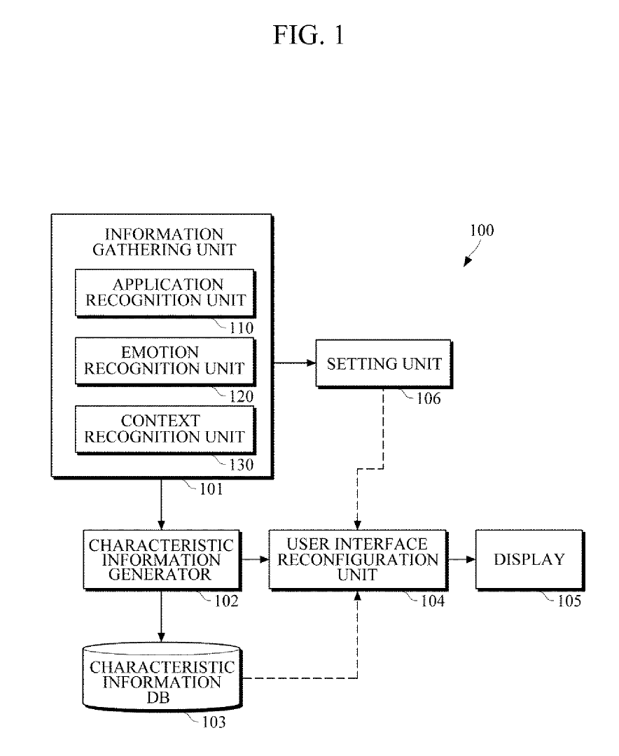

FIG. 1 illustrates an example of an apparatus that provides a user interface.

The apparatus 100 may be installed on a terminal that provides a touch screen-based user interface. For example, the terminal may be a smart phone, a mobile phone, a tablet PC, and the like that are equipped with a touch panel.

Referring to FIG. 1, the apparatus 100 includes an information gathering unit 101, a characteristic information generator 102, a characteristic information database 103, a user interface reconfiguration unit 104, a display unit 105, and a setting unit 106.

The information gathering unit 101 may collect application information, emotion information, and context information. To gather the information, the information gathering unit 101 may include one or more sensors. The application information may be information regarding the applications that are being executed on the terminal. The emotion information may be information regarding the emotional state of a user of the terminal. The context information may be information regarding the circumstance under which the terminal is used.

For example, the information gathering unit 101 may include an application recognition unit 110, an emotion recognition unit 120, and a context recognition unit 130. The information gather unit 101 may include a number of sensors.

The application recognition unit 110 may detect applications that are being executed. For example, the application recognition unit 110 may be a software sensor for detecting identities of applications that are being executed, or a module for receiving the identities of the applications from such a software sensor.

The emotion recognition unit 120 may detect the emotional state of a user of the terminal. For example, the emotion recognition unit 120 may analyze the user's facial image, the user's voice, the user's text, and the like, to recognize the user's emotion. The user's facial image may be acquired from a camera installed in the terminal. The image may be analyzed to determine a facial expression that conveys the user's emotion. The user's voice may be acquired from a microphone installed in the terminal. For instance, the user's emotion may be detected from the user's voice by analyzing the pitch, power, pace, inflection, and the like of the voice. The user's text may be acquired from an application related to text message transmission. For example, the user may use emotion-indicating words such as “happiness,” “grumpy,” and “sad,” or may type in a smiley face, or select an emoticon in sending an e-mail communication or a text message. The method by which the emotion recognition unit 120 may recognize the emotional state of a user is not limited to these examples. In addition, the emotion recognition unit 120 may allocate certain emotion values respectively to different types of individual emotions, such as happiness, sadness, anger, disgust, peace, for instance, and may select a representative emotion based on the emotion values.

The context recognition unit 130 may detect the circumstance under which the terminal is used. For example, the context recognition unit 130 may recognize the location of the terminal, the number of times an application has been executed, weather of the location where the terminal is used, temperature of the location, the time when the terminal is used, whether it is used in an underground tunnel or in the air space, the time zone, the city or country, and the like. The context recognition unit 130 may analyze values sensed by various sensors installed in the terminal, such as a GPS sensor, a temperature sensor, an acceleration sensor, to name a few, to thereby detect the circumstance of use. A method in which the context recognition unit 130 may recognize the circumstance of using the terminal is not limited to these examples. In another example, for instance, when an application is being executed on a terminal, the context recognition unit 130 may detect a time and place at which the application was executed.

In another example, the information gathering unit 101 may be configured with the application recognition unit 110 and the emotion recognition unit 120 or with the application recognition unit 110 and the context recognition unit 130.

The characteristic information generator 102 may generate characteristic information.

According to another example, the characteristic information may include application information, emotion information, and context information, which are acquired by the information gathering unit 101. For example, the characteristic information generator 102 may obtain the characteristic information by combining all or a portion of the application information, the emotion information, and the context information. For instance, when a certain application is executed, the characteristic information generator 102 may map identities of applications that are being executed, as reflected by the application information, user's emotion during the execution of the application, as reflected by the emotion information, and a time and place at which the application is executed, as reflected by the context information, thereby creating a single row of data.

In another example, the characteristic information may be obtained by combining application information and emotion information, and/or combining application information and context information. For instance, the characteristic information may include mapping information between application information and emotion information, and/or mapping information between application information and context information.

The characteristic information generator 102 may generate a row of data as described above for each application whenever an application is executed, and may store a row of data in the form of a table in the characteristic information database 103.

The characteristic information generator 102 may update the characteristic information stored in the characteristic information database 103. For example, in the event that an application that has been previously executed is executed again, there may be an event in which emotion information or context information mapped to the application is changed. In such an event, the characteristic information generator 102 may appropriately combine newly generated characteristic information with the previously stored characteristic information to thereby update the characteristic information. A method of combining characteristic information is not limited thereto. In another example, the characteristic information generator 102 may update the characteristic information using a mean value of the newly generated characteristic information and the previously stored characteristic information, or calculate the mean value after allocating a weight to the newly generated characteristic information and update the characteristic information using the mean value.

The characteristic information database 103 stores the characteristic information generated by the characteristic information generator 102. Details about a format in which the characteristic information is stored are described later.

The user interface reconfiguration unit 104 controls the display unit 105. For example, the user interface reconfiguration unit 104 may control wallpapers, various graphic icons, display effects, and other visual elements that are displayed on the display unit 105.

The user interface reconfiguration unit 104 may dynamically reconfigure graphic objects that are displayed on the display unit 105, using the characteristic information generated by the characteristic information generator 102 or the characteristic information stored in the characteristic information database 103. The graphic objects may include execution icons of applications. The user may touch or click on a graphic object displayed on the display unit 105 to initiate the execution of a corresponding application. For example, the user interface reconfiguration unit 104 may classify the graphic objects using the characteristic information.

In an example, the user interface reconfiguration unit 104 may refer to the emotion information in order to change borders, colors, or sizes of execution icons according to the emotional state of the user. Similarly, the user interface reconfiguration unit 104 may refer to the emotion information in order to group the execution icons into several groups according to the types of emotion associated with the application, or add different identification icons to the execution icons according to the types of emotion associated with the application.

In another example, the user interface reconfiguration unit 104 may refer to the context information to change at least ones of the borders, colors, and sizes of execution icons, according to the context of use, or add different identification icons to execution icons according to the context of use.

The display 105 may be a touch screen that is controlled by the user interface reconfiguration unit 104.

The setting unit 106 may be used to set a method in which the user interface reconfiguration unit 104 reconfigures graphic objects, according to information collected by the information gathering unit 101 or according to a user input. For example, the setting unit 106 may be used to set graphic object representation methods of the user interface reconfiguration unit 104 in accordance with the emotion information regarding the user and/or the context information regarding the use of the terminal as collected by the information gathering unit 101.

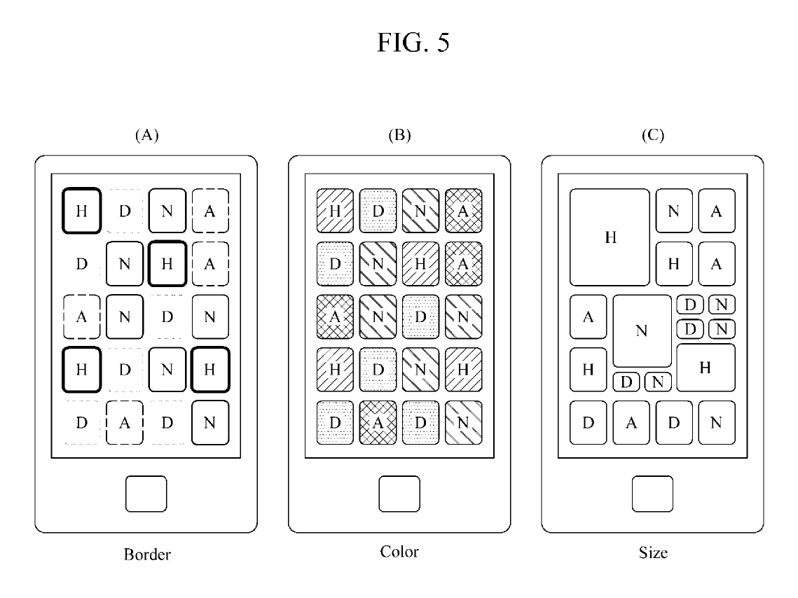

Examples of graphic object representation methods are described in detail with reference to FIGS. 5, 6, and 7, later.

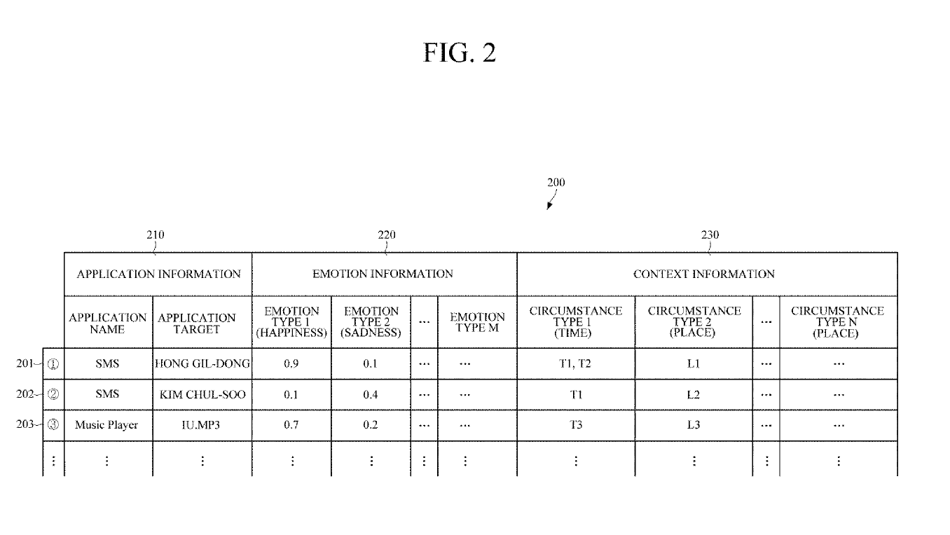

FIG. 2 illustrates an example of characteristic information 200.

Referring to FIGS. 1 and 2, the characteristic information 200 includes application information 210, emotion information 220, and context information 230, which are mapped to each other.

The application information 210 may include application names and application targets. The emotion information 220 may include emotion values corresponding to various types of emotions, such as happiness, sadness, disgust, euphoria, etc. The emotion values may be quantitative. The context information 230 may include context values corresponding to various circumstances under which the terminal is used, such as time, place, weather, and the like during the use of the terminal.

For example, in FIG. 2, a row \textcircled{1} of data 201 represents characteristic information generated when an application related to a SMS service is executed. In this example, row \textcircled{1} of data 201 illustrates that, when the user sent a text message to a person named “Hong Gil-Dong” as indicated by the application information column, the user's main emotion was “happiness” as indicated by the greatest numerical value found in the emotion information column, and mainly two text messages have been sent at times “T1” and “T2” in a place “L1” during the execution.

Also, a row \textcircled{2} of data 202 shows that, when the user sent a text message to another person named “Kim Chul-Soo,” the user's main emotion was “sadness” as indicated by the greatest numerical value, and mainly a text message has been sent at a time “T1” in a place “L2.”

Likewise, a row \textcircled{3} of data 203 shows that, when a music “IU.mp3” was played by a Music Player application, the user was happy and he or she has heard the music at a time “T3” in a place “L3.”

As such, the characteristic information 200 may be generated by combining a variety of information collected by the information gathering unit 101 in the characteristic information generator 102.

Also, the characteristic information 200 may be updated by the characteristic information generator 102. For example, in the case of the row \textcircled{1} of data 201, if the user becomes angry while he or she exchanges text messages with a person named “Hong Kil Dong,” the emotion values of the emotion information 220 may change.

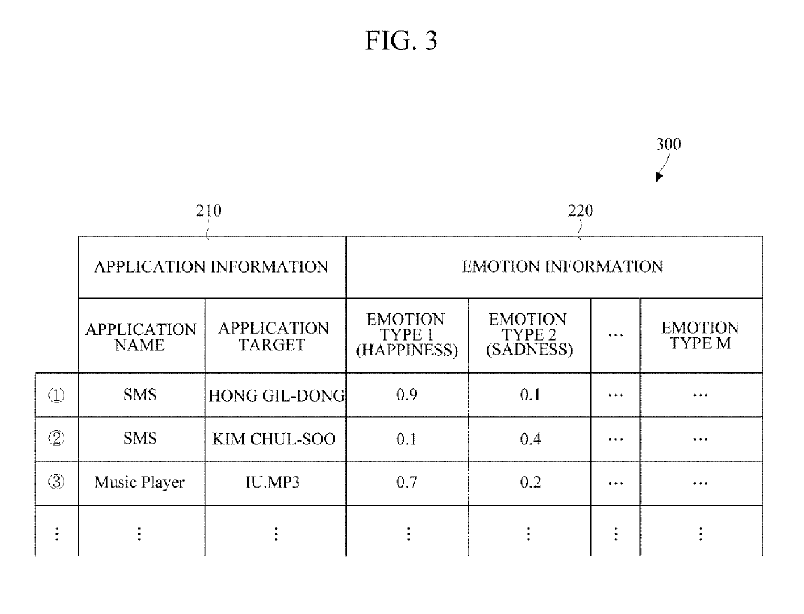

FIG. 3 shows another example of characteristic information 300.

Referring to FIGS. 2 and 3, the characteristic information 300 includes application information 210 and emotion information 220. The characteristic information 300 of FIG. 3 may be configured with a form resulting from excluding the context information 230 from the characteristic information 200 of FIG. 2. For example, if the information gathering unit 101 of FIG. 1 includes no context recognition unit, the characteristic information generator 102 may map values sensed by the application recognition unit 110 and the emotion recognition unit 120 to thereby generate and store the characteristic information 300 as illustrated in FIG. 3.

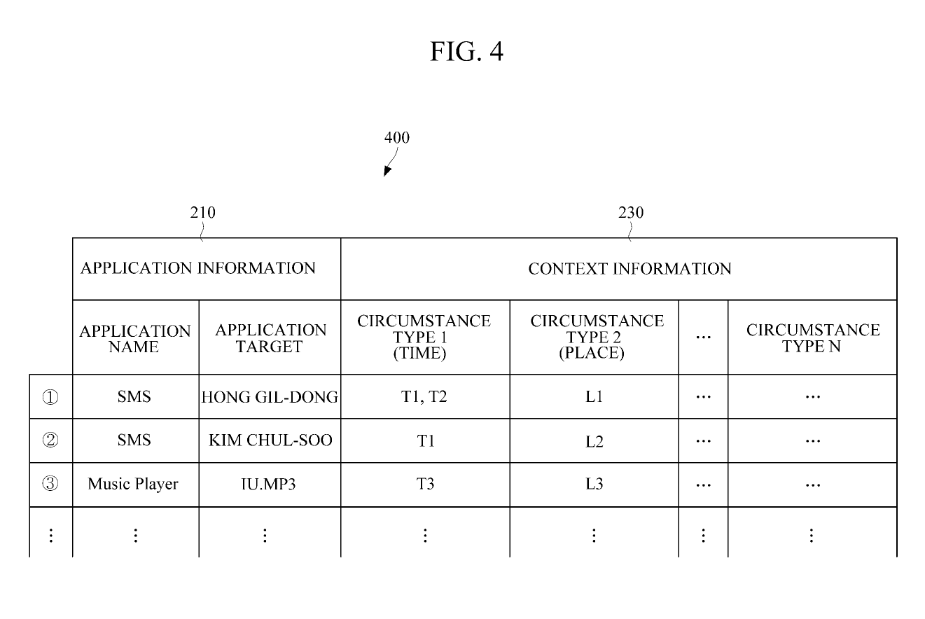

FIG. 4 shows another example of characteristic information 400.

Referring to FIGS. 2 and 4, the characteristic information 400 includes application information 210 and context information 230. The characteristic information of FIG. 4 may be configured with a form resulting from excluding the emotion information 220 from the characteristic information 200 of FIG. 2. For example, referring again to FIG. 1, if the information gathering unit 101 does not include an emotion recognition unit, the characteristic information generator 102 may map values sensed by the application recognition unit 110 and the context recognition unit 130 to thereby generate and store the characteristic information 400 as illustrated in FIG. 4.

FIG. 5 illustrates an example of a graphic object reconfiguration method.

Referring to FIGS. 1 and 5, the user interface reconfiguration unit 104 may change the borders, colors, sizes, and other visual elements of graphic objects related to the execution of applications according to the characteristic information.

For example, the user interface reconfiguration unit 104 may differentiate the borders of graphic objects according to the types of emotions associated with each application. For example, as illustrated in FIG. 5(A), graphic objects “H” may represent execution icons of applications related mainly to happiness, and graphic objects “A” may represent execution icons of applications related mainly to anger. As illustrated in FIG. 5, the user interface reconfiguration unit 104 may represent the borders of execution icons of applications that relate mainly to happiness with thick lines, and the borders of execution icons of applications that relate mainly to anger with dotted lines.

In another example, the user interface reconfiguration unit 104 may apply different colors to graphic objects in accordance with the emotion associated with each application. For example, in FIG. 5(B), graphic objects “H” may represent execution icons of applications that relate mainly to happiness, and the graphic objects “A” may represent execution icons of applications that relate mainly to anger. As illustrated in FIG. 5(B), the user interface reconfiguration unit 104 may apply different colors to execution icons of applications related to happiness and execution icons of applications related to anger.

As another example, the user interface reconfiguration unit 104 may differentiate the sizes of graphic objects according to the types of emotions associated with the applications. For example, in FIG. 5(C), graphic objects “H” may represent execution icons of applications related to happiness, and graphic objects “A” may represent execution icons of applications that relate to anger. As illustrated in FIG. 5(C), the user interface reconfiguration unit 104 may make the sizes of execution icons of applications that relate to happiness to be larger than the execution icons for applications that relate to anger.

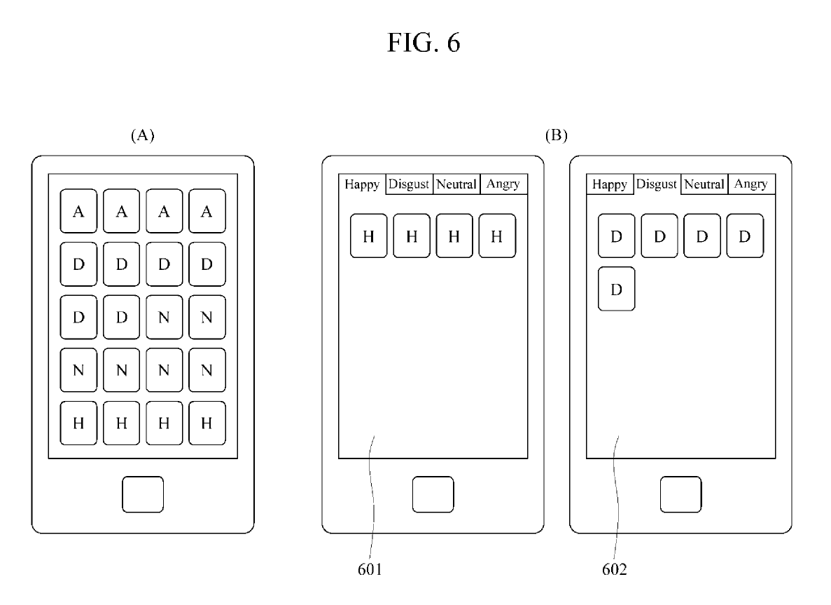

FIG. 6 illustrates another example of a graphic object reconfiguration method.

Referring to FIGS. 1 and 6, the user interface reconfiguration unit 104 may group graphic objects into several groups according to characteristic information related to each application.

For example, the user interface reconfiguration unit 104 may rearrange the order of graphic objects on the display unit in consideration of the types of emotions associated with each application. For example, as illustrated in FIG. 6(A), the graphic objects may be arranged in such a way that graphic objects associated with the same type of emotion are displayed together in a group.

As another example, the user interface reconfiguration unit 104 may layer wallpapers according to the emotions associated with the application and display the corresponding graphic objects on each of the layered wallpapers. For example, as illustrated in FIG. 6(B), graphic objects corresponding to happiness may be expressed on a first level of wallpaper 601, and graphic objects corresponding to disgust may be expressed on a second level of wallpaper 602.

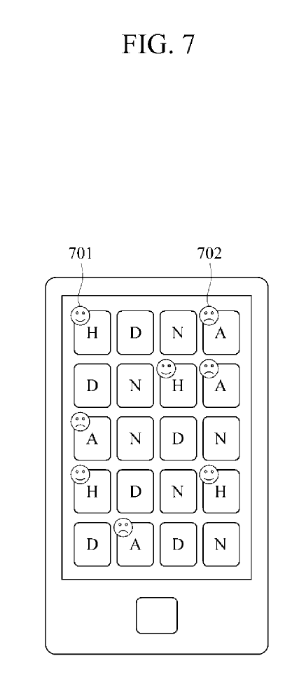

FIG. 7 illustrates another example of a graphic object reconfiguration method.

Referring to FIGS. 1 and 7, the user interface reconfiguration unit 104 may add unique identification icons to graphic objects according to characteristic information. For example, a smiley face icon 701 may be added to graphic objects “H” corresponding to happiness, and an angry face icon 702 may be added to graphic objects “A” corresponding to anger. Smiley faces, happy faces, angry faces are examples of emoticon, which are icons that represent human emotions. For instance, emoticons representing various emotions, such as joy, happiness, indifference, astonishment, melancholy, may be added to the graphic objects.

For illustrative purposes, FIGS. 5, 6, and 7 illustrate various examples in which reconfiguration of graphic objects according to characteristic information is classification of graphic objects according to the types of emotions; however, it is also obvious that graphic objects can be classified according to the circumstance of use. For example, in FIGS. 5, 6, and 7, in consideration of places, “H” may represent applications that have been mainly used in school, and “A” may represent applications that have been mainly used in home. Furthermore, in another example, “H” may represent applications that have been mainly used in school when the user is “Happy”, and “A” may represent applications that have been mainly used in school when the user is “Sad”. In addition, it is also possible that graphic objects are reconfigured according to “Time” or “Weather”.

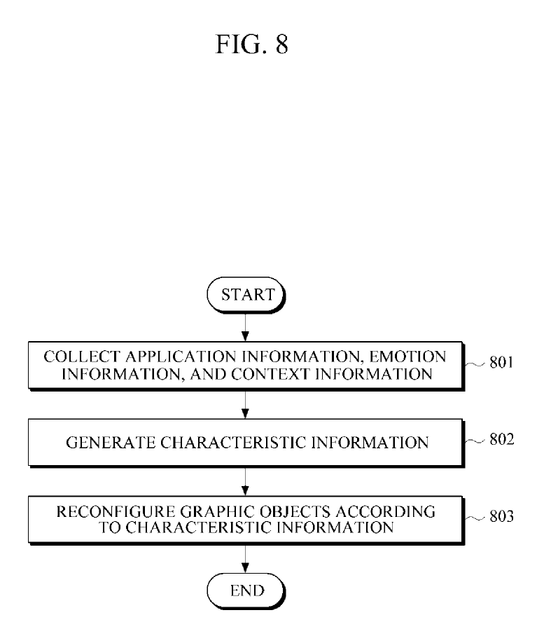

FIG. 8 is a flowchart illustrating an example of a method for providing user interface.

Referring to FIGS. 1 and 8, the method for providing a user interface involves collecting application information, emotion information, and/or context information, as illustrated in 801. For example, the information gathering unit 101 may detect the applications being executed, the emotional state of the user, the circumstance of use of the device, and the like.

Then, the characteristic information is generated in 802 based on the collected information. For example, the characteristic information generator 102 may map, as illustrated in FIGS. 2, 3, and 4, the collected information to thereby generate characteristic information.

Then, graphic objects are reconfigured in accordance with the characteristic information in 803. The graphic objects may be execution icons that control execution of applications. For example, the user interface reconfiguration unit 104 may change, as in the examples illustrated in FIGS. 5, 6, and 7, the borders, colors, or sizes of the graphic objects, group the graphic objects into several groups, and/or add identification icons to the graphic objects, in consideration of the emotional state of the user or the circumstance of use of the device.

According to the examples as described above, since graphic objects are displayed in consideration of a user's emotional state or a terminal's circumstance of use, various interactions can be induced by the user and the convenience of the use of the terminal can be improved.

The method of providing a user interface can be implemented as computer readable codes, which may be recorded in a non-transitory computer readable recording medium. Examples of a computer readable recording medium include all types of recording media in which computer readable data may be stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A unit or a module described herein may be implemented using hardware components and software components. Examples of units and modules include microphones, amplifiers, band-pass filters, audio to digital convertors, processing devices, a processor combined with a camera, etc. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software.

For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors. As used herein, a processing device configured to implement a function A includes a processor programmed to run specific software. In addition, a processing device configured to implement a function A, a function B, and a function C may include configurations, such as, for example, a processor configured to implement both functions A, B, and C, a first processor configured to implement function A, and a second processor configured to implement functions B and C, a first processor to implement function A, a second processor configured to implement function B, and a third processor configured to implement function C, a first processor configured to implement function A, and a second processor configured to implement functions B and C, a first processor configured to implement functions A, B, C, and a second processor configured to implement functions A, B, and C, and so on.

As a non-exhaustive illustration only, a terminal or an apparatus described herein may refer to a mobile device such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, or other device or apparatus capable of wireless communication or network communication. A display unit may include an LCD screen, LED screen, a touch panel, a monitor or other device that provides visual representation of information, regardless of size or form. For example, the display unit may be a touch panel installed on a mobile device, or a screen of a personal digital assistant, a portable lab-top PC, a desktop PC, or a portable multimedia player.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for providing user interface, the apparatus comprising:
an information gathering unit configured to collect application information related to applications that are executed and emotion information related to a user;
a characteristic information generator configured to combine the application information and the emotion information to obtain characteristic information; and
a user interface reconfiguration unit configured to reconfigure graphic objects related to the applications using the characteristic information.

2. The apparatus of claim 1, wherein the apparatus further comprises a display unit configured to display the reconfigured graphic objects.

3. The apparatus of claim 1, further comprising a setting unit configured to set a graphic object reconfiguration method of the user interface reconfiguration unit according to information collected by the information gathering unit or according to a user's input.

4. The apparatus of claim 1, wherein the graphic objects are execution icons of the applications.

5. The apparatus of claim 1, wherein the user interface reconfiguration unit is configured to classify the graphic objects according to the emotion information of the characteristic information.

6. The apparatus of claim 5, wherein the user interface reconfiguration unit is configured to change a border, a color, or a size of at least one of the graphic objects according to the emotion information.

7. The apparatus of claim 5, wherein the user interface reconfiguration unit is configured to group the graphic objects into several groups according to the emotion information.

8. The apparatus of claim 5, wherein the user interface reconfiguration unit is configured to add or update identification icons associated with the graphic objects according to the emotion information.

9. An apparatus for providing user interface, the apparatus comprising:
an information gathering unit configured to collect application information related to applications that are executed and context information related to a use of the apparatus;
is a characteristic information generator configured to combine the application information and the context information to obtain characteristic information; and
a user interface reconfiguration unit configured to reconfigure graphic objects related to the applications using the characteristic information.

10. The apparatus of claim 9, further comprising a setting unit configured to set a graphic object reconfiguration method of the user interface reconfiguration unit according to information collected by the information gathering unit or according to a user's input.

11. The apparatus of claim 9, wherein the graphic objects are execution icons of the applications.

12. The apparatus of claim 9, wherein the user interface reconfiguration unit is configured to classify the graphic objects according to the context information of the characteristic information.

13. The apparatus of claim 12, wherein the user interface reconfiguration unit is configured to change a border, a color, and a size of the graphic objects, according to a circumstance of the use included in the context information of the characteristic information.

14. The apparatus of claim 12, wherein the user interface reconfiguration unit is configured to group the graphic objects into a plurality of groups, according to a circumstance of the use included in the context information of the characteristic information.

15. The apparatus of claim 12, wherein the user interface reconfiguration unit is configured to add or update identification icons associated with the graphic objects, according to a circumstance of the use included in the context information of the characteristic information.

16. An apparatus for providing user interface, the apparatus comprising:
an information gathering unit configured to collect application information related to applications that are executed, emotion information related to a user, and context information related to a use of the apparatus;
a characteristic information generator configured to combine the application information, the emotion information, and the context information to each other to obtain characteristic information; and
a user interface reconfiguration unit configured to dynamically reconfigure graphic objects related to the applications using the characteristic information.

17. The apparatus of claim 16, further comprising a setting unit configured to set a graphic object reconfiguration method of the user interface reconfiguration unit according to information collected by the information gathering unit or according to a user's input.

18. The apparatus of claim 16, wherein the graphic objects are execution icons of the applications.

19. The apparatus of claim 16, wherein the user interface reconfiguration unit is configured to classify the graphic objects in considerations of at least one type of emotion included in the emotion information or at least one type of circumstance included in the context information.

20. The apparatus of claim 19, wherein the user interface reconfiguration unit is configured to change a border, a color, or a size of one of the graphic objects according to the emotion information or according to the context information.

21. The apparatus of claim 19, wherein the user interface reconfiguration unit is configured to group the graphic objects into a plurality of groups according to the emotion information or according to the context information.

22. The apparatus of claim 19, wherein the user interface reconfiguration unit is configured to add or update identification icons associated with the graphic objects according to the emotion information or according to the context information.

23. A method for providing user interface, the method comprising:
collecting application information related to applications that are executed, emotion information related to a user, and context information related to a use of an apparatus;
combining at least two pieces of the application information, the emotion information, and the context information to each other to obtain characteristic information; and
reconfiguring graphic objects that are displayed on a screen using the characteristic information.

24. The method of claim 23, the method further comprising:
retrieving the characteristic information from a memory storage; and
dynamically reconfiguring the graphic objects displayed on the screen,
wherein the graphic objects include an execution icon of at least one of the applications.

25. The method of claim 23, wherein the graphic objects include an execution icon displayed on the screen of a mobile terminal.

26. The method of claim 23, wherein the reconfiguring of the graphic objects involves:
changing a color of the graphic objects displayed on the screen;
changing a border of the graphic objects displayed on the screen;
changing a size of the graphic objects displayed on the screen;
changing a shape of the graphic objects displayed on the screen; or
adding or changing an identification icon associated with the graphic objects on the screen.

27. The method of claim 24, wherein the memory storage is configured to store the characteristic information related to a past history of a user's emotion associated with using at least one of the applications.

28. The method of claim 24, wherein the memory storage is configured to store the characteristic information related to a past history of a use of at least one of the applications.

29. A non-transitory computer readable medium, the medium configured to cause a computer to perform the method of claim 23.
